(19) United States
(12) Patent Application Publication
(10) Pub. No.: US 2017/0010988 A1
(43) Pub. Date: Jan. 12, 2017

(54) ACTIVATION METHOD OF A UNIVERSAL SERIAL BUS COMPATIBLE FLASH DEVICE AND RELATED UNIVERSAL SERIAL BUS COMPATIBLE FLASH DEVICE

(71) Applicant: Etron Technology, Inc., Hsinchu (TW)

(72) Inventor: Hsuan-Ching Chao, Keelung City (TW)

(21) Appl. No.: 14/920,890

(22) Filed: Oct. 23, 2015

(30) Foreign Application Priority Data
Jul. 7, 2015 (TW) 104121969

(51) Int. Cl. G06F 13/16; G06F 13/40; G06F 3/06

(52) U.S. Cl. CPC G06F 13/1668; G06F 3/0604; G06F 3/0629; G06F 3/0679; G06F 13/4068

(57) ABSTRACT

An activation method of a universal serial bus (USB) compatible flash device is disclosed, wherein the USB compatible flash device includes a controller and a pair of signal pins, and the controller includes a memory and a microprocessor. The activation method includes when the USB compatible flash device is coupled to a host, the pair of signal pins receiving a pair of predetermined signals, and transmitting the pair of predetermined signals to the microprocessor, wherein the pair of signal pins are different from a power line pin and a ground pin of the USB compatible flash device; when the microprocessor receives the pair of predetermined signals through the pair of signal pins, the microprocessor determining that a force event occurs; and after the microprocessor determines that the force event occurs, the microprocessor activating the USB compatible flash device according to an original activation program stored in the memory.

### BACKGROUND OF THE INVENTION

1. Field of the Invention

The present invention relates to an activation method of a universal serial bus (USB) compatible flash device and a USB compatible flash device thereof, and particularly to an activation method and a USB compatible flash device thereof that can utilize a microprocessor to activate the USB compatible flash device according to a pair of predetermined signals and an original activation program stored in a memory.

2. Description of the Prior Art

Please refer to FIG. 1. FIG. 1 is a flowchart illustrating an activation procedure of a USB compatible flash device. As shown in FIG. 1, after the USB compatible flash device is connected to a host (Step 102), a controller of the USB compatible flash device can execute the following steps: determining whether a force event occurs (Step 104), verifying whether a data structure table is correct (Step 106), and if a firmware can be downloaded to a static random access memory (SRAM) of the controller from a flash memory of the USB compatible flash device (Step 108), wherein the data structure table corresponds to locations of good memory blocks of the flash memory (for storing data), bad memory blocks of the flash memory, and memory blocks of the flash memory occupied by data, and Steps 104-108 are called a normal activation procedure. After Step 104-108 are executed completely, the controller can normally activate the USB compatible flash device according to the firmware downloaded to the static random access memory (Step 110), wherein the controller can further determine a surplus capacity of the flash memory according to the firmware downloaded to the static random access memory and the data structure table. In addition, when the force event occurs, the data structure table is incorrect, or the firmware fails to be downloaded to the static random access memory of the controller, the controller is forced to activate the USB compatible flash device according to an original activation program stored in a read-only memory of the controller (Step 112). After the controller utilizes the original activation program to activate the USB compatible flash device, the controller can analyze a reason of failure of the normal activation procedure according to the original activation program, and exclude the reason of failure of the normal activation procedure accordingly. However, sometimes the controller cannot normally execute Step 112 itself, resulting in a user failing to utilize the USB compatible flash device.

Please refer to FIG. 2. FIG. 2 is a diagram illustrating the prior art utilizing a General Purpose Input/Output (GPIO) pin GPIOP to force a controller 202 to activate a USB compatible flash device 204 according to an original activation program stored in a read-only memory 2022. As shown in FIG. 2, when the controller 202 cannot activate the USB compatible flash device 204 according to the above mentioned normal activation procedure and an original activation program stored in the read-only memory 2022, a manufacturer of the USB compatible flash device can electrically connect the General Purpose Input/Output pin GPIOP to ground GND before the USB compatible flash device 204 is electrically connected to a host (after the USB compatible flash device 204 is electrically connected to the host, the manufacturer of the USB compatible flash device can disconnect the General Purpose Input/Output pin GPIOP with the ground GND). Therefore, when the USB compatible flash device 204 is electrically connected to the host, the controller 202 can be forced to activate the USB compatible flash device 204 according to the original activation program stored in the read-only memory 2022 because the General Purpose Input/Output pin GPIOP is electrically connected to the ground GND.

However, it is obvious that the prior art in FIG. 2 needs to be implemented by an additional pin (that is, the General Purpose Input/Output pin GPIOP), resulting in cost of the USB compatible flash device 204 being increased. In addition, the prior art in FIG. 2 cannot be applied to a USB compatible flash device with chip on board (COB).

### SUMMARY OF THE INVENTION

An embodiment of the present invention provides an activation method of a universal serial bus (USB) compatible flash device, wherein the flash device includes a controller and a pair of signal pins, and the controller includes a memory and a microprocessor. The activation method includes when the USB compatible flash device is coupled to a host, the pair of signal pins receiving a pair of predetermined signals, and transmitting the pair of predetermined signals to the microprocessor, wherein the pair of signal pins are different from a power line pin and a ground pin of the USB compatible flash device; when the microprocessor receives the pair of predetermined signals through the pair of signal pins, the microprocessor determining that a force event occurs; and after the microprocessor determines that the force event occurs, the microprocessor activating the USB compatible flash device according to an original activation program stored in the memory.

Another embodiment of the present invention provides a USB compatible flash device. The USB compatible flash device includes a controller and a pair of signal pins, wherein the controller includes a memory and a microprocessor. The pair of signal pins are used for receiving a pair of predetermined signals, and transmitting the pair of predetermined signals to the microprocessor when the USB compatible flash device is coupled to a host, wherein the pair of signal pins are different from a power line pin and a ground pin of the USB compatible flash device. When the microprocessor receives the pair of predetermined signals through the pair of signal pins, the microprocessor determines that a force event occurs, and after the microprocessor determines that the force event occurs, the microprocessor activates the USB compatible flash device according to an original activation program stored in the memory.

The present invention provides an activation method of a USB compatible flash device and a related USB compatible flash device thereof. The activation method and the USB compatible flash device utilize a pair of signal pins to receive a pair of predetermined signals different from a pair of normal signals, and utilize a microprocessor to determine that a force event occurs according to the pair of predetermined signals. After the microprocessor determines that the force event occurs according to the pair of predetermined signals, the microprocessor can activate the USB compatible flash device and analyze a reason of failure of a normal activation procedure according to an original activation program stored in a memory, and exclude the reason of failure of the normal activation procedure accordingly. Therefore, compared to the prior art, the present invention has advantages as follows: first, because the present invention does not need to be implemented by an additional pin, the present invention can reduce cost thereof; second, because the present invention does not need to be implemented by the additional pin, convenience of the present invention is better; and third, the present invention can be applied to a Chip On Board (COB).

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart illustrating an activation procedure of a USB compatible flash device.

FIG. 2 is a diagram illustrating the prior art utilizing a General Purpose Input/Output (GPIO) pin to force a controller to activate a USB compatible flash device according to an original activation program stored in a read-only memory.

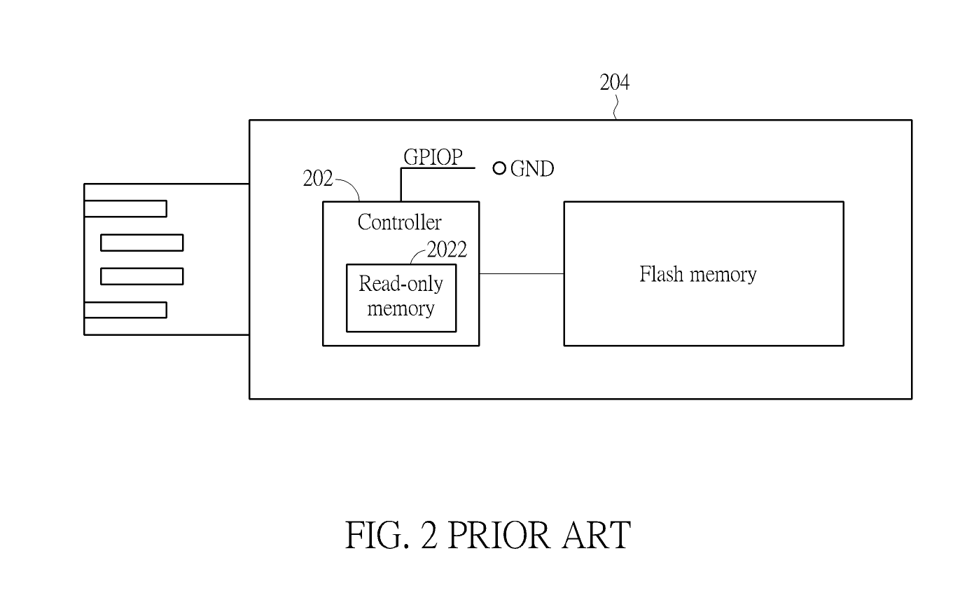

FIG. 3 is a diagram illustrating a universal serial bus (USB) compatible flash device according to a first embodiment of the present invention.

FIG. 4 is a flowchart illustrating an activation method of a USB compatible flash device according to a second embodiment of the present invention.

FIG. 5 is a diagram illustrating the USB compatible flash device, the host, and the device.

FIG. 6 is a diagram illustrating the pair of predetermined signals, the pair of normal signals, and the power signal.

FIG. 7 is a diagram illustrating the signal pin electrically connected to the first double-pole switch receiving the logic-high voltage and the signal pin electrically connected to the second double-pole switch receiving the logic-high voltage.

### DETAILED DESCRIPTION

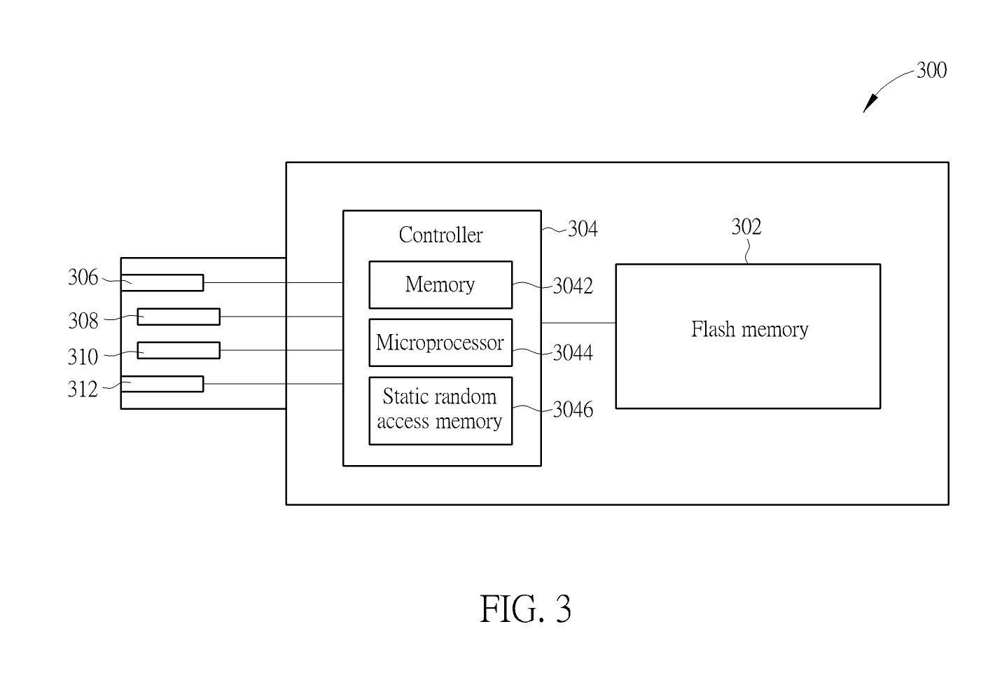

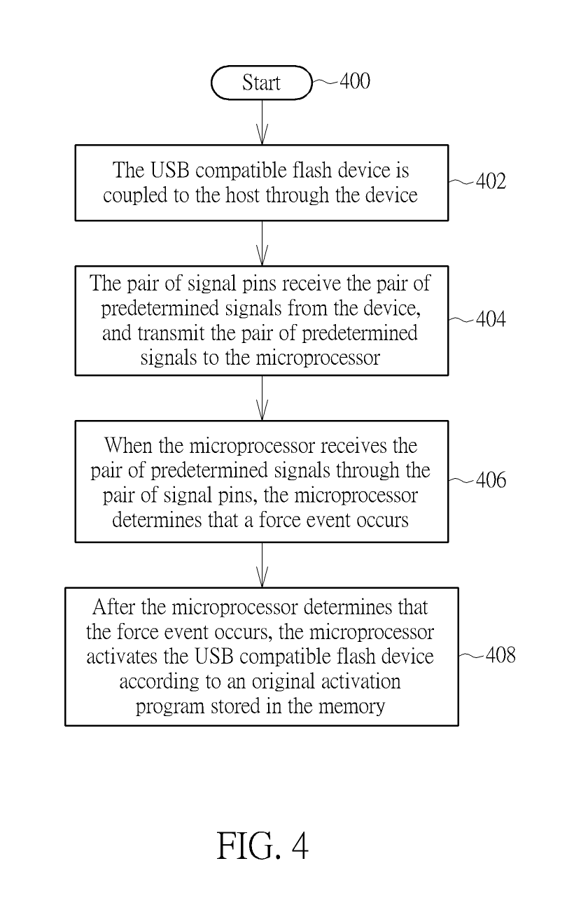

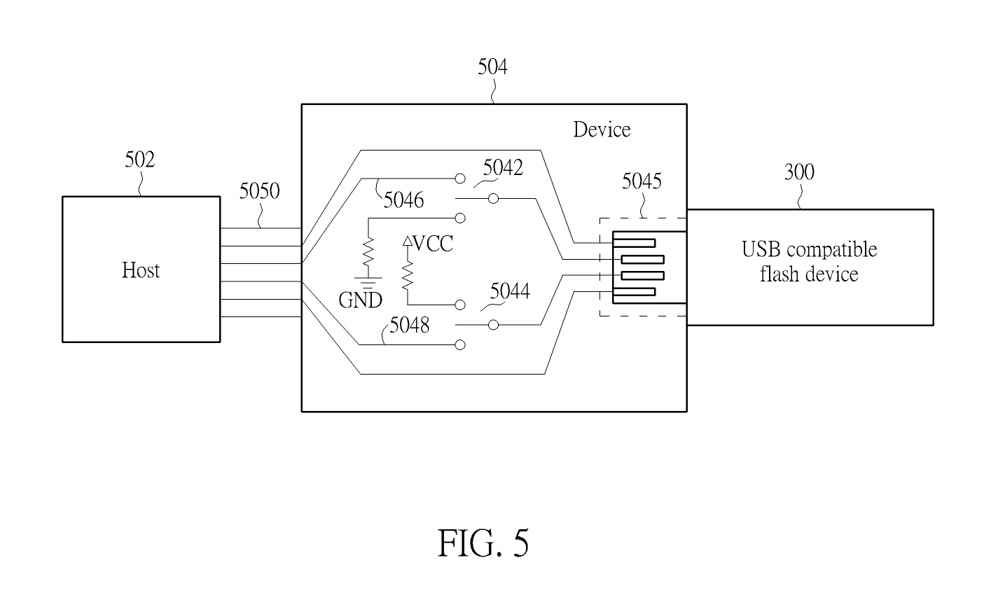

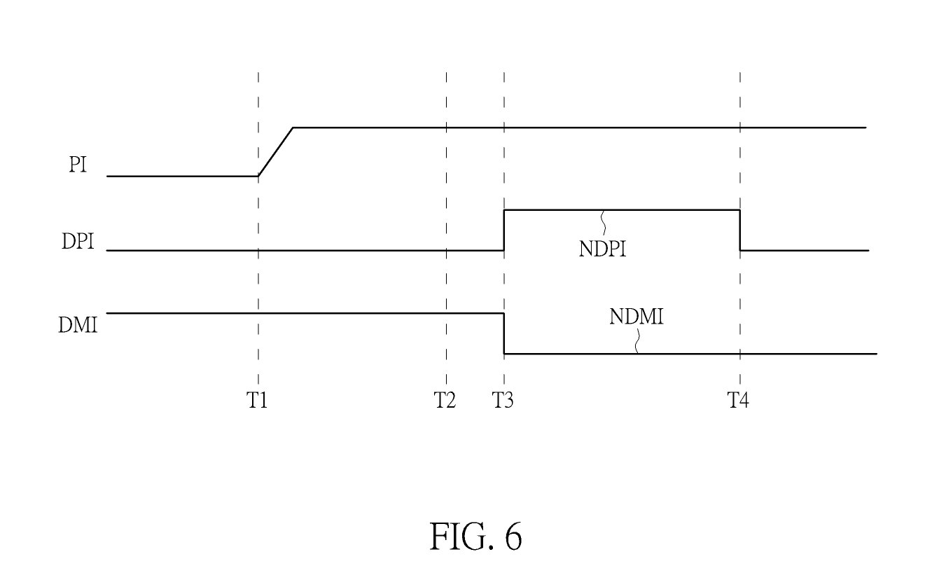

Please refer to FIG. 3. FIG. 3 is a diagram illustrating a universal serial bus (USB) compatible flash device 300 according to a first embodiment of the present invention, wherein the USB compatible flash device 300 includes a flash memory 302, a controller 304, a power line pin 306, a pair of signal pins 308, 310, and a ground pin 312, the controller 304 includes a memory 3042, a microprocessor 3044, and a static random access memory (SRAM) 3046, the memory 3042 is a read-only memory (ROM), and the pair of signal pins 308, 310 are a signal D+ pin and a signal D− pin, respectively (that is, the pair of signal pins 308, 310 are different from the power line pin 306 and the ground pin 312). However, when the USB compatible flash device 300 is a USB 3.0 flash device or a USB 3.1 flash device, the USB compatible flash device 300 is not limited to only including the power line pin 306, the pair of signal pins 308, 310, and the ground pin 312 (that is, the USB compatible flash device 300 can include other pins except the power line pin 306, the pair of signal pins 308, 310, and the ground pin 312), and the pair of signal pins 308, 310 are also not limited to being the signal D+ pin and the signal D− pin (that is, when the USB compatible flash device 300 is a USB 3.0 flash device or a USB 3.1 flash device, the pair of signal pins 308, 310 can be a signal SSRX+ pin and a signal SSRX− pin). Please refer to FIG. 4. FIG. 4 is a flowchart illustrating an activation method of a USB compatible flash device according to a second embodiment of the present invention. The activation method in FIG. 4 is illustrated using the USB compatible flash device 300, a host 502, and a device 504 shown in FIG. 5 and a pair of predetermined signals DPI, DMI, a pair of normal signals NDPI, NDMI, and a power signal PI shown in FIG. 6. Detailed steps are as follows:

Step 400: Start.

Step 402: The USB compatible flash device 300 is coupled to the host 502 through the device 504.

Step 404: The pair of signal pins 308, 310 receive the pair of predetermined signals DPI, DMI from the device 504, and transmit the pair of predetermined signals DPI, DMI to the microprocessor 3044.

Step 406: When the microprocessor 3044 receives the pair of predetermined signals DPI, DMI through the pair of signal pins 308, 310, the microprocessor 3044 determines that a force event occurs.

Step 408: After the microprocessor 3044 determines that the force event occurs, the microprocessor 3044 activates the USB compatible flash device 300 according to an original activation program stored in the memory 3042.

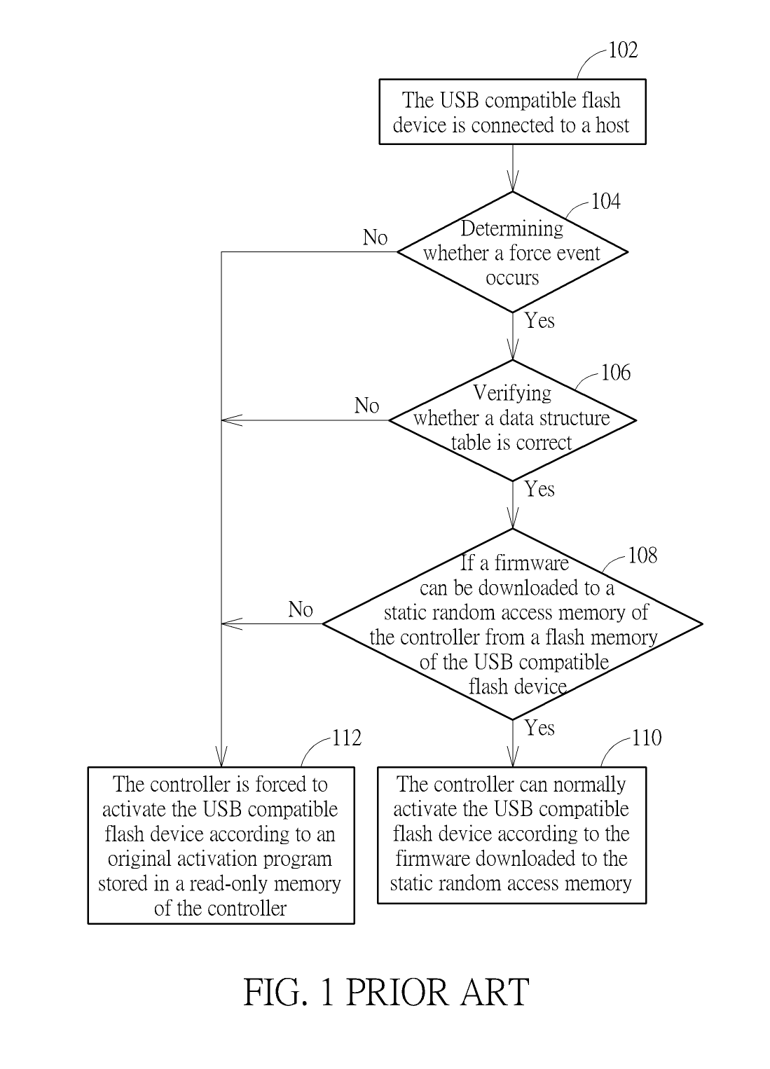

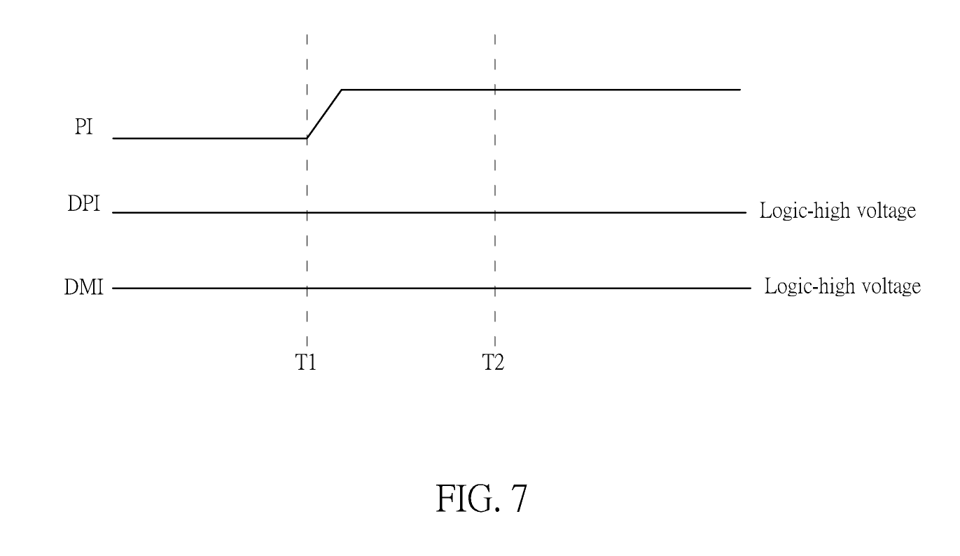

As shown in FIG. 5, before a manufacturer of the USB compatible flash device 300 couples the USB compatible flash device 300, the host 502, and the device 504 together according to coupling relationships shown in FIG. 5, the manufacturer of the USB compatible flash device 300 can control the device 504 to make a first double-pole switch 5042 and a second double-pole switch 5044 of the device 504 be switched to ground GND and a high voltage VCC, respectively, wherein the present invention is not limited to a circuit structure of the device 504. In Step 402, when the USB compatible flash device 300 cannot be activated according to the normal activation procedure as shown in FIG. 1, the manufacturer of the USB compatible flash device 300 can couple the USB compatible flash device 300, the host 502, and the device 504 together according to the coupling relationships shown in FIG. 5, wherein the device 504 has a slot 5045, and the power line pin 306, the pair of signal pins 308, 310, and the ground pin 312 can be coupled to the device 504 through the slot 5045. In Step 404, as shown in FIG. 6, after the USB compatible flash device 300 is coupled to the host 502 through the device 504, because the first double-pole switch 5042 and the second double-pole switch 5044 are switched to the ground GND and the high voltage VCC, respectively, the signal pin 308 electrically connected to the first double-pole switch 5042 can receive the predetermined signal DPI (a logic-low voltage) and the signal pin 310 electrically connected to the second double-pole switch 5044 can receive the predetermined signal DMI (a logic-high voltage). In addition, in another embodiment of the present invention, the first double-pole switch 5042 and the second double-pole switch 5044 can be switched to the high voltage VCC, respectively, so as shown in FIG. 7, the signal pin 308 electrically connected to the first double-pole switch 5042 can receive the predetermined signal DPI (the logic-high voltage) and the signal pin 310 electrically connected to the second double-pole switch 5044 can receive the predetermined signal DMI (the logic-high voltage). In addition, when the USB compatible flash device 300 is a USB 3.0 flash device or a USB 3.1 flash device, because the pair of signal pins 308, 310 can be a signal SSRX+ pin and a signal SSRX− pin, respectively, the device 504 can generate a corresponding pair of predetermined signals according to the signal SSRX+ pin and the signal SSRX− pin and a USB 3.0 specification (or a USB 3.1 specification). In Step 406, as shown in FIG. 6, because the controller 304 is coupled to the pair of signal pins 308, 310, the microprocessor 3044 can also receive the pair of predetermined signals DPI, DMI through the controller 304. After the host 502 transmits the power signal PI to the power line pin 306 (wherein the host 502 transmits the power signal PI to the power line pin 306 at a time T1), the microprocessor 3044 can determine that the force event occurs at a time T2 because of receiving the pair of predetermined signals DPI, DMI. In Step 408, as shown in FIG. 6, after the microprocessor 3044 determines that the force event occurs, the microprocessor 3044 can activate the USB compatible flash device 300 according to the original activation program stored in the memory 3042. Then, after the microprocessor 3044 utilizes the original activation program to activate the USB compatible flash device 300 successfully, the manufacturer of the USB compatible flash device 300 can control the device 504 to make the first double-pole switch 5042 and the second double-pole switch 5044 be switched to signal lines 5046, 5048 respectively at a time T3, wherein the signal lines 5046, 5048 are used for receiving a pair of normal signals NDPI (the logic-high voltage), NDMI (the logic-low voltage) from the host 502 through a USB cable 5050, and the pair of predetermined signals DPI, DMI are different from the pair of normal signals NDPI, NDMI. After the signal lines 5046, 5048 receive the pair of normal signals NDPI, NDMI, the microprocessor 3044 can start to analyze a reason of failure of the normal activation procedure at a time T4 according to the original activation program, and exclude the reason of failure of the normal activation procedure. After the microprocessor 3044 excludes the reason of failure of the normal activation procedure, the manufacturer of the USB compatible flash device 300 can remove the device 504. In addition, another regular function of the flash memory 302 is used for storing data, so further description thereof is omitted for simplicity. However, if the microprocessor 3044 cannot exclude the reason of failure of the normal activation procedure, the manufacturer of the USB compatible flash device 300 can determine that the USB compatible flash device 300 fails accordingly.

To sum up, the activation method of a USB compatible flash device and the related USB compatible flash device thereof utilize the pair of signal pins to receive the pair of predetermined signals different from the pair of normal signals, and utilize the microprocessor to determine that the force event occurs according to the pair of predetermined signals. After the microprocessor determines that the force event occurs according to the pair of predetermined signals, the microprocessor can activate the USB compatible flash device and analyze the reason of failure of the normal activation procedure according to the original activation program stored in the memory, and exclude the reason of failure of the normal activation procedure accordingly. Therefore, compared to the prior art, the present invention has advantages as follows: first, because the present invention does not need to be implemented by an additional pin, the present invention can reduce cost thereof; second, because the present invention does not need to be implemented by the additional pin, convenience of the present invention is better; and third, the present invention can be applied to a Chip On Board (COB).

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An activation method of a universal serial bus (USB) compatible flash device, wherein the USB compatible flash device comprises a controller and a pair of signal pins, and the controller comprises a memory and a microprocessor, the activation method comprising:
when the USB compatible flash device is coupled to a host, the pair of signal pins receiving a pair of predetermined signals, and transmitting the pair of predetermined signals to the microprocessor, wherein the pair of signal pins are different from a power line pin and a ground pin of the USB compatible flash device;
when the microprocessor receives the pair of predetermined signals through the pair of signal pins, the microprocessor determining that a force event occurs; and
after the microprocessor determines that the force event occurs, the microprocessor activating the USB compatible flash device according to an original activation program stored in the memory.

2. The activation method of claim 1, wherein the memory is a read-only memory (ROM).

3. The activation method of claim 1, wherein the pair of signal pins are a signal D+ pin and a signal D− pin, respectively.

4. The activation method of claim 1, wherein the pair of predetermined signals are a logic-low voltage and a logic-high voltage, or two logic-high voltages.

5. The activation method of claim 1, wherein the USB compatible flash device is coupled to the host through a device, and the USB compatible flash device receives the pair of predetermined signals from the device.

6. A USB compatible flash device, comprising:
a controller, comprising:
a memory ; and
a microprocessor; and
a pair of signal pins receiving a pair of predetermined signals, and transmitting the pair of predetermined signals to the microprocessor when the USB compatible flash device is coupled to a host, wherein the pair of signal pins are different from a power line pin and a ground pin of the USB compatible flash device;
wherein when the microprocessor receives the pair of predetermined signals through the pair of signal pins, the microprocessor determines that a force event occurs, and after the microprocessor determines that the force event occurs, the microprocessor activates the USB compatible flash device according to an original activation program stored in the memory.

7. The USB compatible flash device of claim 6, wherein the memory is a read-only memory.

8. The USB compatible flash device of claim 6, wherein the pair of signal pins are a signal D+ pin and a signal D− pin, respectively.

9. The USB compatible flash device of claim 6, wherein the pair of predetermined signals are a logic-low voltage and a logic-high voltage, or two logic-high voltages.

10. The USB compatible flash device of claim 6, wherein the USB compatible flash device is coupled to the host through a device, and the pair of signal pins are received the pair of predetermined signals from the device.
